(19) United States
(12) Patent Application Publication
(10) Pub. No.: US 2024/0175355 A1
(43) Pub. Date: May 30, 2024

(54) METHOD FOR EVALUATING PRODUCTIVITY OF VERTICALLY HETEROGENEOUS GAS RESERVOIR CONSIDERING INTERLAYER CROSSFLOW

(71) Applicants: Hainan Branch of China National Offshore Oil (China) Co., Ltd., Haikou (CN); Hainan Branch of China France Bohai Geoservices Co., Ltd, Haikou (CN)

(72) Inventors: Changgui XU, Haikou (CN); Shusheng GUO, Haikou (CN); Hao LIANG, Haikou (CN); Xiaojun XIN, Haikou (CN)

(21) Appl. No.: 18/230,895

(22) Filed: Aug. 7, 2023

(30) Foreign Application Priority Data
Nov. 28, 2022 (CN) 202211700091.0

(51) Int. Cl. E21B 49/08; E21B 47/12; E21B 49/10

(52) U.S. Cl. CPC E21B 49/0875; E21B 47/138; E21B 49/10

(57) ABSTRACT

A method for evaluatingproductivity of a vertically heterogeneous gas reservoir considering interlayer crossflow is disclosed in the invention, and includes: (1) dividing a heterogeneous gas reservoir into multiple thin layersvertically; (2) obtaining the productivity of each thin layer according to data obtained through wireline formation test; (3) superimposing the productivity of all thin layers based on the water-electricitysimilarityprinciple to obtain the superimposed productivity of the heterogeneousgas reservoir; and (4) using an interlayer crossflow correction coefficient considering influence caused by the interlayer crossflow to obtain the corrected productivity of the heterogeneousgas reservoir. Specific to the vertically heterogeneous characteristics of the gas reservoir, a gas reservoir section is divided into several different flow units, such that a reservoir with strong heterogeneity is converted into relatively homogeneous reservoir sections, and the productivity thereof is determined using the data obtained through wireline formation test, considering the influence of the interlayer crossflow in a vertically heterogeneous reservoir on productivity prediction, which has more accurate prediction results.

### TECHNICAL FIELD

The invention relates to the technical field of oil and gas field exploration and production engineering, and in particular, to a method for evaluating productivity of a vertically heterogeneous gas reservoir considering interlayer crossflow:

### BACKGROUND

Productivity prediction is a crucial link for research of oil and gas field development engineering, and determines not only the industrial development value of oil and gas reservoirs but also the investment scale for the development of oil and gas reservoirs. Compared with terrestrial gas reservoirs, deep water gas reservoirs have huge development investment, and high-productivity evaluation or low-productivity prediction affects the exploration and production of gas reservoirs. Preferable selection of high-yield reservoirs through accurate evaluation on productivity of gas reservoirs is a key technology to achieve the efficient development of Deepwater gas fields. In the prior art, drill system test (DST) and wireline formation test (WFT) are conventional methods for evaluating the productivity of each thin layer, but the drill system test is expensive in cost, and offshore gas field test is relatively less used. By comparison, the wireline formation test has great advantages in terms of environment, safety, and economy, and the productivity of each thin layer can be predicted through evaluation on the seepage capability of underground fluid.

An offshore of low-porosity and low-permeability reservoir has remarkable feature of strong vertical heterogeneity. Generally, under conditions of similar burial depth, lithology, horizon, facies zone, and diagenetic background, the thin layers have great difference in physical property and productivity, which brings great difficulty to productivity prediction. For vertically heterogeneous reservoirs, when the productivity prediction is made in the prior art, multiple thin layers close to each other are considered as a whole as seepage unit, and interlayer crossflow caused by heterogeneous differences among different thin layers is ignored, which leads to the deviation of productivity evaluation.

### SUMMARY

In view of problems in the prior art, the invention provides a method for evaluating productivity of a vertically heterogeneous gas reservoir considering interlayer crossflow.

The invention is implemented by a method for evaluating productivity of a vertically heterogeneous gas reservoir considering interlayer crossflow, and the method for evaluating productivity of a vertically heterogeneous gas reservoir includes the following steps:
(1) dividing a heterogeneous reservoir into multiple thin layers vertically;
(2) obtaining the productivity of each thin layer according to data obtained through wireline formation test:
(3) superimposing the productivity of each thin layer based on the water-electricitysimilarityprinciple to obtain the superimposed productivity of the gas reservoir; and
(4) using an interlayer crossflow correction coefficient considering influence caused by the interlayer crossflow to obtain the corrected comprehensive productivity of the gas reservoir.

Preferably, Step (1) includes vertically dividing the reservoir into several different flow units according to permeability obtained through logging data, where each of the flow units is a relatively homogeneous thin layer.

Preferably, in Step (1), a first wireline formation tester and a second wireline formation tester are vertically arranged at different-depth locations, respectively: the pumping speed of the first wireline formation tester is changed, pressure variation of the probe of the second wireline formation tester in another thin layer is observed, then whether an adjacent thin layer pertains to a same seepage unit is determined according to the pressure variation of the probe of the second wireline formation tester.

Preferably, the determining whether an adjacent thin layer pertains to a same seepage unit according to the pressure variation of the probe of the second wireline formation tester includes: if pressure measured by the second wireline formation tester is changed along with that measured by the first wireline formation tester, the two thin layers pertain to the same seepage unit: or if pressure measured by the second wireline formation tester is not changed along with disturbance, the two thin layers are two independent seepage units.

Preferably, Step (2) includes using static permeability Kₛ obtained through the wireline formation test and permeability K_{g (1-Sw)} obtained through core displacement test to establish a conversion relation K_{g (1-Sw)}=f (Kₛ), and obtaining effective permeability K_{g (1-Sw)} based on data obtained through the wireline formation test.

Preferably, Step (2) includes establishing a conversion relation of measured productivity Qᵢ and effective permeability K_{g (1-Sw)} according to the measured productivity relation of the section of the thin layer in this block.

Preferably, the conversion relation is Qᵢ-a*K^{b}_{g (1-Sw)}+C, wherein a, b, and c are fitting coefficients.

Preferably, the conversion relation is validated and corrected using field DST test data.

Preferably, the productivity of each thin layer is calculated based on a calculation formula (1):

$${q}_{s c} = \frac{- A + \sqrt{{A}^{2} - 4 B ( ψ ( {p}_{w f} ) - ψ ( {p}_{e} ) ) + C}}{2 B}$$

Preferably, the superimposed productivity of the gas reservoir is that of all thin layers, namely:

$$\begin{matrix}{Q}_{t o l} = {\sum }_{i = 1}^{n} {q}_{i} \\ {Q}_{m} = {α}^{*} {Q}_{t o l}\end{matrix}$$

where Qₜₒₗ is the superimposed productivity of the gas reservoir:
qᵢ is the productivity of the i(th) reservoir section:
a is the correction coefficient for the interlayer crossflow; and
Om is the corrected comprehensive productivity of the gas reservoir.

With reference to all the technical solutions, the invention has the advantages and effective effects that: specific to the vertically heterogeneous characteristics of the gas reservoir, a gas reservoir section is divided into several different flow units, such that a complex reservoir with strong heterogeneity is converted into relatively homogeneous reservoir sections, and the productivity of the reservoir sections is determined using data obtained through wireline formation test, considering the influence of the interlayer crossflow in a vertically heterogeneous reservoir on productivity prediction, which has more accurate prediction results.

### BRIEF DESCRIPTION OF DRAWINGS

To describe the technical solutions in embodiments of the invention or in the prior art more clearly, the following briefly describes the accompanying drawings required for describing the embodiments or the prior art. Apparently, the accompanying drawings in the following descriptions show some embodiments of the invention, and persons of ordinary skill in the art may still derive other drawings from the accompanying drawings without creative efforts.

FIG. 1 is a flow diagram of a method according to an embodiment of the invention.

FIG. 2 is a schematic diagram of interlayer crossflow in a heterogeneous gas reservoir according to an embodiment of the invention.

FIG. 3 is a schematic diagram of plotting of Lorenz curve when a flow variation coefficient is obtained according to an embodiment of the invention.

### DESCRIPTION OF EMBODIMENTS

Details of the invention can be more clearly understood with reference to the accompanying drawings and the descriptions of embodiments of the invention. However, the embodiments of the invention described herein are used to explain the invention only, but do not constitute any limitation on the invention in any way. Any possible variations based on the invention may be conceived by persons of ordinary skill in the art in the light of the teachings of the invention, and these should be considered to fall within the scope of the invention.

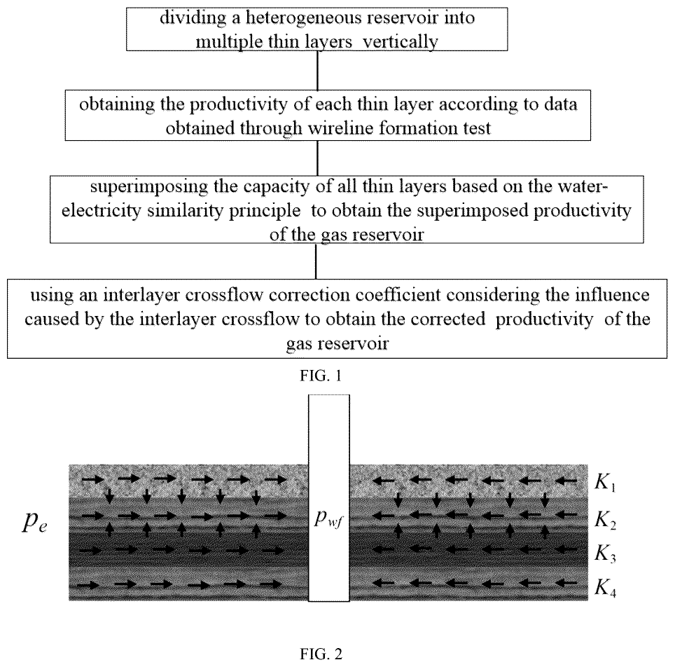

In view of problems in the prior art, as shown in FIG. 1, the invention provides a method for evaluating productivity of a vertically heterogeneous gas reservoir considering interlayer crossflow; and the method includes the following steps of:

(1) dividing a heterogeneous reservoir into multiple thin layers vertically:

(2) obtaining the productivity of each thin layer according to data obtained through wireline formation test:

(3) superimposing the productivity of all thin layers based on the water-electricity similarity principle to obtain the superimposed productivity of the gas reservoir; and

(4) using an interlayer crossflow correction coefficient considering influence caused by the interlayer crossflow to obtain the corrected comprehensive productivity of the gas reservoir.

In Step (1), in order to distinguish the thin layers, the reservoir is divided into several micro-scale lithologicfacies units by utilizing logging data obtained through electric imaging and combining diagenesis based on the accurate identification of lithology and sedimentary bedding structure, thereby depicting the vertically heterogeneity characteristics of the reservoir.

Under the restriction of lithologicfacies unit framework, a reservoir quality factor and a flow unit index are used to establish a flow unit model, and the static permeability of each thin layer of various flow units is obtained through the multivariate fitting of logging data.

A reservoir whose vertical permeability can be reflected through logging data can be vertically divided into several different flow units according to permeability obtained through logging data, where each of the flow units is a relatively homogeneous thin layer.

For a reservoir with large characteristic difference in pore throat structure and permeability and small logging response among different flow units, logging data cannot accurately reflect whether an adjacent thin layer pertains to the reservoir in a same flow unit, so a wireline formation test method can be adopted for such determination. A first wireline formation tester and a second wireline formation tester are vertically arranged at different-depth locations, respectively, where the first wireline formation tester and the second wireline formation tester are set in different thin layers, respectively: the pumping speed of the first wireline formation tester is changed, such that pressure wave disturbance is generated in the reservoir section, and pressure variation of the probe of the second wireline formation tester in another thin layer is observed. If pressure measured by the second wireline formation tester is changed along with that measured by the first wireline formation tester, the two thin layers are interconnected, pertain to the same seepage unit, and can be classified as a same thin layer. If pressure measured by the second wireline formation tester is not changed along with disturbance, the two thin layers are two independent seepage units, instead of being interconnected.

In Step (2), for various thin layers obtained by dividing each thin layer in Step (1), static permeability Kₛ obtained through the wireline formation test and permeability K_{g (1-Sw)} obtained through core displacement test are used to establish a conversion relation K_{g (1-Sw)}=f (Kₛ), thereby quickly obtaining the effective permeability K_{g (1-Sw)} of the reservoir section based on data obtained through the wireline formation test.

Further, a conversion relation of measured productivity Qᵢ and effective permeability K_{g (1-Sw)} is established according to the measured productivity relation of the section of the thin layer in this block, thereby realizing the rapid productivity prediction of untested well sections in the reservoir section.

In an embodiment, a relational expression obtained through fitting is Qᵢ-α*K^{b}_{g (1-Sw)}+c, where a, b, and c are fitting coefficients, and the error of the fitting relation satisfies the requirement through validation of field DST test data.

In an embodiment, for a single-phase gas seepage vertical well, the productivity can be calculated based the following calculation:

$${q}_{s c} = \frac{- A + \sqrt{{A}^{2} - 4 B ( ψ ( {p}_{w f} ) - ψ ( {p}_{e} ) ) + C}}{2 B}$$

$$where ,$$

$$A = \frac{6.367 \times 1 {0}^{- 4} T {e}^{( - b ( {p}_{e} - \overline{p} ) )}}{{K}_{0} h} ln ( \frac{{r}_{e}}{{r}_{w}} )$$

$$where ,$$

$$B = \frac{1.0795 \times 1 {0}^{- 10} {γ}_{g} T {e}^{( - b ( {p}_{e} - \overline{p} ) )}}{{K}^{1.5} {h}^{2} \overline{μ}} ( \frac{1}{{r}_{w}} - \frac{1}{{r}_{e}} )$$

$$C = λ ( \frac{{p}_{e} + {p}_{w f}}{2} ) ( {r}_{e} - {r}_{w} ) \frac{{e}^{( - b ( {p}_{e} - \overline{p} ) )}}{\overline{μ} \overline{Z}}$$

In the formula, q_{sc} is the gas production rate under standard conditions, m³/d;

$$ψ ( p ) = {\int }_{{p}_{0}}^{p} \frac{{pe}^{( - b ( {p}_{e} - \overline{p} ) )}}{μ Z}$$

is the pseudo-pressure function of single-phase gas;
T is reservoir temperature;
Pe. P̅, p_{wf}, and p are respectively original reservoir pressure, mean reservoir pressure, bottom hole flowing pressure, and pressure at any point in formation, MPa;
K and K₀ are respectively reservoir permeability at pressure of p and permeability at the original reservoir pressure, mD;
h is reservoir thickness, m;
rₑ and r_{w} are respectively discharge radius and shaft radius, m;
Y is the relative density of natural gas;
b is a stress sensitivity coefficient, MPa⁻¹;
μ and μ̅ are respectively natural gas viscosity and mean natural gas viscosity, mPa·s;
λ is starting pressure gradient, MPa/m; and
Z and Z̅ are respectively a deviation coefficient and a mean deviation coefficient.

In Step (3), after the productivity of each thin layer is obtained by the method in Step (2), based on the equivalent seepage principle, several vertically heterogeneous reservoirs are equivalent resistors connected in parallel, so that the superimposed productivity of the gas reservoir is that of all thin layers, namely:

$${Q}_{t o l} = {\sum }_{i = 1}^{n} {q}_{i}$$

Where Qₜₒₗ is the superimposed productivity of the gas reservoir;
qᵢ is the productivity of the i(th) reservoir section.

In Step (4), considering influence caused by the interlayer crossflow, an interlayer crossflow correction coefficient is used to obtain the corrected comprehensive productivity of the gas reservoir.

During the development of vertically heterogeneous gas reservoirs, commingling production is often adopted: with the continuous decrease of the pressure of the gas reservoir, the phenomenon of pressure difference attenuation occurs due to a difference in permeability, fluid property, and other parameters of small vertically heterogeneous reservoirs in a specified period of time or a specified local range, which leads to imbalance of pressure among different gas reservoirs and formation of interlayer pressure difference. In case of specified connectivity among the different gas reservoirs, gas flows from a high-pressure reservoir to a low pressure reservoir under the drive of the interlayer pressure difference, thereby forming interlayer crossflow in the heterogeneous gas reservoir, as shown in FIG. 2. If influence caused by the interlayer crossflow is ignored when the productivity of the vertically heterogeneous gas reservoirs is evaluated, the calculated productivity is prone to be deviated.

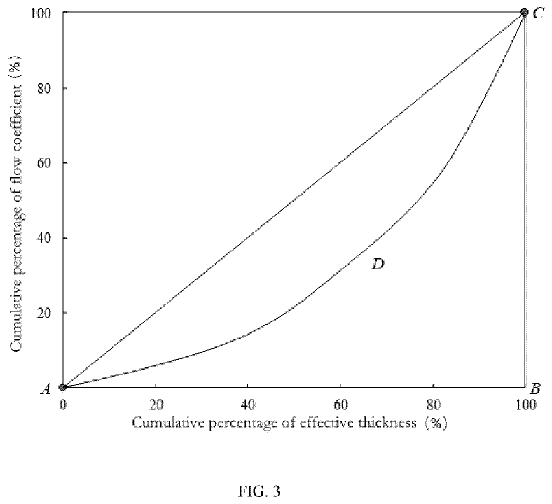

In order to consider the influence caused by the interlayer crossflow of the heterogeneous reservoir, an interlayer crossflow correction coefficient is introduced in this application. The interlayer crossflow correction coefficient is specifically obtained by the following method: calculating corresponding flow coefficients of various thin layers according to the permeability, effective thickness, and gas viscosity of various small heterogeneous gas reservoir: arranging the flow coefficients into a sequence from small to large: calculating the cumulative percentages of flow coefficients and effective thicknesses of the various thin layers, respectively: plotting Lorenz curve on a rectangular coordinate paper (as shown in FIG. 3): calculating a ratio of an envelope area S_{ADCA} to a triangle area S_{ABC} as a flow variation coefficient β (when flow variation coefficient β=0) is satisfied, an interlayer is homogeneous; and when flow variation coefficient β=1 is satisfied, an interlayer is extremely heterogeneous): using a relation curve of an interlayer interference coefficient γ and a flow variation coefficient β to calculate the interlayer interference coefficient γ due to good correlation between them; and then calculating the interlayer crossflow correction coefficient according to formula α=1−γ.

Qₘ=α*Qₜₒₗ

Where Qₘ is the corrected comprehensive productivity of the gas reservoir.

Although the embodiments of the invention have been detailed with reference to the accompanying drawings, it should not be construed as a limitation on the protection scope of this patent. Within the scope as described in claims, various modifications and variations that may be made by persons of ordinary skill in the art without creative efforts fall within the protection scope of this patent.

1. A method for evaluating productivity of a vertically heterogeneous gas reservoir considering interlayer crossflow, comprising the following steps:
(1) dividing a heterogeneous gas reservoir into multiple thin-layers vertically;
(2) obtaining the productivity of each thin-layer according to data obtained through wireline formation test;
wherein, the productivity of the reservoirs is calculated according to the calculation formula (1):
$${q}_{s c} = \frac{- A + \sqrt{{A}^{2} - 4 B ( ψ ( {p}_{w f} ) - ψ ( {p}_{e} ) ) + C}}{2 B}$$
$$where ,$$
$$A = \frac{6.367 \times 1 {0}^{- 4} T {e}^{( - b ( {p}_{e} - \overline{p} ) )}}{{K}_{0} h} ln ( \frac{{r}_{e}}{{r}_{w}} )$$
$$where ,$$
$$B = \frac{1.0795 \times 1 {0}^{- 10} {γ}_{g} T {e}^{( - b ( {p}_{e} - \overline{p} ) )}}{{K}^{1.5} {h}^{2} \overline{μ}} ( \frac{1}{{r}_{w}} - \frac{1}{{r}_{e}} )$$
$$C = λ ( \frac{{p}_{e} + {p}_{w f}}{2} ) ( {r}_{e} - {r}_{w} ) \frac{{e}^{( - b ( {p}_{e} - \overline{p} ) )}}{\overline{μ} \overline{Z}}$$
q_{sc} is the gas production rate under standard conditions, in the units of m³/d;
$$ψ ( p ) = {\int }_{{p}_{0}}^{p} \frac{p {e}^{( - b ( {p}_{e} - \overline{p} ) )}}{μ Z}$$
is the pseudo-pressure function of single-phase gas;
T is reservoir temperature;
pₑ, P̅, P_{wf}, p are respectively original reservoir pressure, mean reservoir pressure, bottom hole flowing pressure, and pressure at any point in formation, in the units of MPa;
K and K₀ are respectively reservoir permeability at pressure of p and permeability at the original reservoir pressure, in the units of mD;
h is reservoir thickness, in the units of m;
rₑ and r_{w} are respectively discharge radius and shaft radius, in the units of m;
Y_{g} is the relative density of natural gas;
b is a stress sensitivity coefficient, in the units of MPa⁻¹;
μ and μ̅ are respectively natural gas viscosity and mean natural gas viscosity, m the units of mPa·s;
2 is starting pressure gradient, in the units of MPa m; and
Z and Z̅ are respectively a deviation coefficient and a mean deviation coefficient;
(3) superimposing the productivity of all thin layers based on the water-electricity similarity principle to obtain the superimposed productivity of the whole heterogeneous gas reservoir;
Wherein the superimposed productivity of the gas reservoir is that of all thin-layers, namely:
$$\begin{matrix}{Q}_{t o l} = {\sum }_{i = 1}^{n} {q}_{i} \\ {Q}_{m} = {α}^{*} {Q}_{t o l}\end{matrix}$$
where Qₜₒₗ is the superimposed productivity of the gas reservoir;
qᵢ is the productivity of the i(th) reservoir section of the gas reservoir;
a is the correction coefficient of the layer cross flow; and
Qₘ is the corrected comprehensive productivity of the gas reservoir;
wherein the interlayer crossflow correction coefficient is specifically obtained by the following method:
calculating corresponding flow coefficients of various thin-layers according to the permeability, effective thickness, and gas viscosity of various small heterogeneous gas reservoir; arranging the flow coefficients into a sequence from small to large; calculating the cumulative percentages of flow coefficients and effective thicknesses of the various thin layers, respectively; plotting Lorenz curve on a rectangular coordinate paper;
calculating a ratio of an envelope area S_{ADCA} to a triangle area S_{ABC} as a flow variation coefficient β; using a relation curve of an interlayer interference coefficient γ and a flow variation coefficient β to calculate the interlayer interference coefficient γ; and then calculating the interlayer crossflow correction coefficient according to formula α=1−γ; and
(4) using an interlayer crossflow correction coefficient considering influence caused by the interlayer crossflow to obtain the corrected comprehensive productivity of the whole gas reservoir.

2. The method for evaluating productivity of a vertically heterogeneous gas reservoir considering interlayer crossflow according to claim 1, wherein Step (1) comprises vertically dividing the reservoir into several different flow units according to permeability obtained through conventional logging data, wherein each of the flow units is a relatively homogeneous thin-layer.

3. The method for evaluating productivity of a vertically heterogeneous gas reservoir considering interlayer crossflow according to claim 1, wherein Step (1) comprises vertically arranging a first wireline formation tester and a second wireline formation tester at different depths in the vertical direction, respectively: changing the pumping speed of the first wireline formation tester, observing the pressure variation of the probe of the second wireline formation tester in another thin-layer, then determining whether an adjacent thin layer pertains to a same seepage unit according to the pressure variation of the probe of the second wireline formation tester.

4. The method for evaluating productivity of a vertically heterogeneous gas reservoir considering interlayer crossflow according to claim 3, wherein the determining whether the adjacent layer pertains to a same seepage unit according to the pressure variation of the probe of the second wireline formation tester comprises:
if pressure measured by the second wireline formation tester is changed along with that measured by the first wireline formation tester, the two thin-layers pertain to the same seepage unit: or
if pressure measured by the second wireline formation tester is not changed along with disturbance, the two thin-layers are two independent seepage units.

5. The method for evaluating productivity of a vertically heterogeneous gas reservoir considering interlayer crossflow according to claim 1, wherein Step (2) comprises using static permeability Kₛ obtained through the wireline formation test and permeability K_{g (1-Sw)} obtained through core displacement test to establish a conversion function relation K_{g (1-Sw)}=f (Kₛ), and obtaining effective permeability K_{g (1-Sw)} based on the data obtained through the wireline formation test.

6. The method for evaluating productivity of a vertically heterogeneous gas reservoir considering interlayer crossflow according to claim 1, wherein Step (2) comprises establishing a conversion relation of measured productivity Qᵢ and effective permeability K_{g (1-Sw)} according to the measured productivity relation of the section of the thin layer in this block.

7. The method for evaluating productivity of a vertically heterogeneous gas reservoir considering interlayer crossflow according to claim 6, wherein the conversion function relation is Qᵢ=α+K^{b}_{g (1-Sw)}+c, wherein a, b, and c are fitting coefficients.

8. The method for evaluating productivity of a vertically heterogeneous gas reservoir considering interlayer crossflow according to claim 7, wherein the conversion function relation is validated and corrected using field DST test data.

9-10. (canceled)
